(19) United States
(12) Patent Application Publication
(10) Pub. No.: US 2021/0065223 A1
(43) Pub. Date: Mar. 4, 2021

(54) SURVEY DATA COLLECTION, ANALYSIS, AND CATEGORIZATION SYSTEMS AND METHODS

(71) Applicant: EVOLVED EXPERIENCE SOLUTIONS, INC., FRESNO, CA (US)

(72) Inventors: Erin Blecha-Ward, Fresno, CA (US); Jason Nikowitz, (US); Ryan Devlin, Palo Alto, CA (US)

(21) Appl. No.: 17/009,749

(22) Filed: Sep. 1, 2020

Related U.S. Application Data
(60) Provisional application No. 62/894,844, filed on Sep. 1, 2019.

(51) Int. Cl. G06Q 30/02; G06Q 10/10; G06N 20/00

(52) U.S. Cl. CPC G06Q 30/0203; G06N 20/00; G06Q 30/0282; G06Q 10/10

(57) ABSTRACT

A survey data analysis platform and methods for collecting, analyzing, and delivering processed and actionable survey data to producers and managers of events (e.g., a concert, sporting event, convention, etc.) and other social experiences (e.g., an amusement park, a museum, a convention, etc.) in real time. The survey data analysis platform may be operable to collect survey, analyze, and deliver a computational analysis of the survey data in real time to the producer or manager of an in-person event or entertainment experience, enabling real time monitoring of the event and/or experience and the ability to change, remedy, or adjust to attendee concerns and preferences during an event.

### FIELD OF THE INVENTION

The present invention relates to data collection, analysis, and reporting system for public events that is operable to optimize survey structures and weighting to enable more accurate assessments of attendee experience, produce real time dynamic reporting of actionable data analysis, and methods of doing the same.

### DISCUSSION OF THE BACKGROUND

Survey systems for public events, such as sporting events, concerts, festivals, conventions, conferences, amusement parks, and other large gatherings are often used to gauge the attendee experience. However, aside from very obvious issues raised by attendee responses (e.g., “it was difficult to find the bathrooms”, “the public address system was too loud”, “the food is lousy”, etc.), it is notoriously difficult to translate survey data into meaningful improvements in attendee experience that provide advantages to the front-line staff and employees responsible for putting on the event to increase the experience over competitors. For instance, it is very difficult to determine which kinds of amenities and experiences are most important to attendees, and therefore it is difficult for public event producers to make choices about where to improve services and spend capital on improvements, even when armed with general attendee survey data. Additionally, many visitors to these events do not share their contact information so those creating the experience have no way to solicit feedback after the fact or follow-up directly with attendees to gain an understanding of their time at the event. Historically, event producers ask for overall, general enjoyment ratings without specific, actionable elements, making it difficult to improve upon

Conventional methods of analyzing survey data typically include simple review of rating responses made by the attendees (e.g., on a numerical scale of 1 to 10) to determine the attendees' opinions of various features of the venue, performance of the staff, quality of amenities, entertainment quality, ease of use and enjoyment of the event. Such survey data has limited utility because there are no mechanisms for (1) assessing which questions or topics in the survey are most important to attendees and have the greatest impact on their willingness and likelihood to return, endorse and spend with a brand or service, and (2) assessing how well the survey data represents the attending group.

Additionally, existing survey systems do not provide survey data results and analysis in real time to a usable display interface that can be viewed by event personnel as the event is being held. Typically, a brand sends out an assessment to guests 24-48 hours after an event concludes to gather guest perspectives. There is a large body of work on the impact of human memory rapidly declining after the 12-hour mark and further more after that point introducing a great deal of error into the results of post-event surveys as guests forget the details and therefore, guess. Brands are then acting on data that is inaccurate in many cases, and generalized in others, making it an imprecise tool for determining budget resources and other business concerns. An event producer receives survey results after a collection period and typically well after the event occurred. Thus, such survey systems provide no ability to the event producer to change, remedy, or adjust to attendee concerns and preferences during an event. The survey data can only be used after the event occurred for the benefit of refining the next event.

Therefore, improved, efficient, and reliable survey data collection and analysis systems for attendee experiences at public events are needed, particularly in a post-pandemic world in which guests are going to need to reacclimatize to social settings and new restrictions and protocols are in place, having real-time feedback and the ability to immediately support guest needs is paramount to small, medium and large businesses being able to survive and thrive long-term. Such improved systems would facilitate improved event experiences for fans and better success for the event producers and brands looking to get immediate, actionable data to enhance their in-real-life experiences.

### SUMMARY OF THE INVENTION

The present invention provides a survey data analysis platform and methods for collecting, analyzing, and delivering processed and actionable survey data to producers and managers of events (e.g., a concert, sporting event, convention, etc.) and other social experiences (e.g., an amusement park, a museum, a convention, etc.) in real time. The survey data analysis platform may be operable to collect survey, analyze, and deliver a computational analysis of the survey data in real time to the producer or manager of an in-person event or entertainment experience, enabling real time monitoring of the event and/or experience and the ability to change, remedy, or adjust to attendee concerns and preferences during an event. The survey data analysis platform may include one or more computing systems (e.g., server, general purpose computers, etc.) operable to execute survey result analysis operations that (1) analyze the survey results to determine the ordinal data (e.g., ranking values on a scale) provided by the attendees to each survey question, (2) evaluate the importance of each survey question and/or survey question category and assign priorities to the survey questions and/or categories to enable the event/experience producer to determine which attendee concerns are most important to attendee experience, and (3) deliver the analysis to event/experience producer or manager in real time. This survey data analysis platform prompts guests at the event or social experience simultaneously in a broadcast fashion to engage all fans equally and in real-time to minimize the latency effect while affording all attendees the opportunity to participate and provide feedback.

The survey data analysis platform may be configured to deliver customer surveys to the attendees of an event or experience during a pre-determined period (e.g., during the event or social experience). The attendees may be provided the survey through a mobile-computing devices (e.g., a smart phone, smart watch, tablet, or other mobile computing device) through a web-based portal or an application downloaded onto the attendee's mobile computing device. The attendee may be prompted to respond to survey questions during the event by one or several prompts. In some embodiments, a machine-readable code (e.g., an optical label, such as a QR code, or a survey URL) may be presented onsite at the event to allow the attendees to link to a survey provided through the survey collection and analysis system. The machine-readable code may be presented through various means at the event, such as a large digital screen (e.g., a scoreboard, or large digital display over a stage, etc.), smaller digital screens mounted in a venue, digital or tangible posters or signage at the event, or other means. In some embodiments, attendees may be prompted by notifications sent to their mobile computing devices (e.g., text messages, push notifications, SMS message, etc.) with links to a survey or other communication. The survey data analysis platform may be operable to automatically distribute survey or machine code notifications to any smart device connected the Wi-Fi provided by the event or host of the entertainment experience. For example, the host Wi-Fi may utilize routing technology, such as a captive portal system, to automatically redirect network traffic to the survey page during a given time period or during initial connection. The survey data analysis platform may also be configured to operate a dedicated open Wi-Fi network to collect surveys that may be turned on and off during a predetermined time. For example, users that are in proximity to the dedicated Wi-Fi network (but are not connected) may automatically be notified on their smart device that an open Wi-Fi, prompting the users to connect to the dedicated Wi-Fi network. The notifications or machine-readable code may also prompt the attendee to download a mobile application associated with the event or experience, the entertainer(s) present at the event, and/or the event producer.

The attendee may respond to the survey through the web-portal or mobile application, answering one or more of the survey questions which are then passed into the data collection and analysis process conducted by a set of machine executable instructions that analyze the survey answers, the attendee profile, various metadata relating to the time, location, and activity of the attendee at the time their survey responses were submitted. The machine executable instructions may generate an overall satisfaction score for the event, and analyses of each individual survey questions and/or survey question category to determine attendee satisfaction with various aspects of the event, the relative importance of various aspects of the event or experience, and the relative importance of the survey questions and categories themselves. Such event aspects may include concessions, lavatories, venue comfort and convenience (e.g., with respect to seating, stairs, views of the stage, field or other focal points, parking convenience, etc.), venue staff performance, entertainment value of the event's central features (e.g., sports competition, concert performers, stage performers such actors and comedians, etc.) or the experience's central features (e.g., amusement rides, themed performances, exhibits, etc.). The analysis of the survey questions and categories may be organized by the machine executable instructions into modules for presentation to an event producer, such that the data analysis conveys useful and actionable information. Survey category scores may be individually provided, along with relative priority or weighting values of the category with respect to the calculated importance attendees attribute to each category.

The data analysis may be provided to the event/experience producer through a dynamic dashboard that presents the data analysis through a graphical user interface. The graphical user interface displayed on the dynamic dashboard, may also be accessed through a remote client portal, enabling the producer to interact with the dashboard without having to be physically present. The dynamic dashboard may include several dashboard modules, each present different forms of survey data analysis, including a general satisfaction score calculated from the survey data provided by attendees, raw response volumes to each survey question and survey category; prioritization analysis of each category to inform the event producer as to which survey categories are the most important to the overall experience of the attendees; survey response results for particular categories of attendees based on various criteria such as location of attendee (e.g., assigned seat or section, etc.), age, gender, the people with whom the person attended the event (e.g., alone, with friends, with family, with significant other, with work colleagues, etc), ticket category (e.g., season ticket holder vs. single game ticket), price paid or for attendee ticket, seat assignment, and/or other profile data collected through the survey or otherwise; time of survey response relative to event; and priority ranking of specific offerings of the event within a category (e.g., within the concessions category, priority ranking of concession service, food quality, options, wait time, value/cost, and convenience, such as proximity to seat assignment). Analysis of specific demographics are conducted based on age, gender, group (e.g., family group attending), price paid per ticket, and other data, where the survey data and analysis of that data may be broken out by specific demographic categories, in order to provide analysis relevant to specific types of events and/or experiences. For instance, a data analysis system of the survey data analysis platform autonomously breaks out survey analysis specific to females over forty years of age, which can be used to optimize the experience and satisfaction of a concert event for a musical act that is known to appeal to such demographic (e.g., Barry Manilow). The survey data analysis platform dashboard may allow the event or experience producer to isolate specific demographic analysis applicable to an upcoming event. The data analysis system may also be operable to generate a predictive model of what aspects of the event (e.g., parking, ease of access, concessions, etc.) the likely attendees of the event will most value. This predictive modeling provides guidance to the event producer as to what aspects of the event to focus on and enhance to optimize guest satisfaction with the particular event.

The data analysis system may also evaluate the amount spent by the attendee in the event or experience (the “spend”), which may be used as a measure of satisfaction with the event or experience, and may be evaluated in connection with survey questions and categories to determine which aspects of the event are best correlated with guest satisfaction. The data received for each of these categories can be received on a continuous basis during the event or experience and incorporated into the raw data set for the data analysis system to analyze, and the data analysis may be updated in real time during the event/experience that may be provided through the dashboard modules in the dynamic dashboard accessible to the event/experience producer.

The real-time data analysis provided through the survey data platform dashboard may allow an event producer to review the data analysis during the event, and make changes that are responsive to attendees' concerns and preferences. For example, if the event is a concert, and the attendee survey data responses indicate that a significant number of attendees feel the sound system is too loud, the event producer may adjust the volume levels of the venue sound system at an appropriate opportunity to provide a better overall attendee experience. Also, as responses come in, respondents who indicate unsatisfactory experiences may trigger alerts and notifications that go directly to the event producers or leadership of the brand so they may address in real time and provide elevated customer service. The data analysis system may flag these individuals requiring additional support by detecting if they score ordinal rankings low, indicate key words or phrases in their open-ended response, have overall low scores and reflect certain demographic profiles or request additional support. The alert and flagging of these requests may delivered to the staff and producer/manager of the event or experience with an indication of the issue, the guest location, contact method, and suggested action item to remedy the situation. For example, one or more guests/attendees may have had a confrontation with an unruly guest, and the guests/attendees may submit a complaint notification through the web-portal or web application that are delivered in real time to the producer and/or staff of the event or experience. The data associated with the complaint notification may indicate the location of the guest(s) submitting the complaint to the producer and/or staff of the event or experience. In some embodiments, the location of the guest(s) may be determined by location data based on geolocation data collected from the guests' mobile computing devices through the mobile application, WiFi probe analysis to determine which WiFi access point to which the guests' mobile computing devices are connected, data provided by the guest (e.g., guest locating a pin on a digital map), or by other appropriate methods. In some embodiments, the survey data analysis platform may send alert notifications to event staff near the location of the guest(s) providing the alert, who may be identified by geolocation data collected from the staff mobile computing devices through the staff mobile applications, WiFi probe analysis to determine which WiFi access point to which the guests' mobile computing devices are connected, or by other appropriate methods.

Additionally, analysis of the survey data may be conducted by analysis of aggregated data from multiple events conducted by the event/experience producer to provide a more robust data set for each survey question and each survey category of data received through the survey data gathering process. The data analysis system may also analyze the data between events to determine whether any quantitative changes in the survey data have occurred and whether any such changes in the data may be correlated with changes to a particular event or any differences between events. The aggregated data resulting ongoing survey offerings can be analyzed by the data analysis system to produce aggregated analysis regarding attendee/guest satisfaction with different aspects of related events or entertainment experiences over time. For example, survey data may be taken from multiple concert events to determine optimum sound system volume levels based on survey data from multiple concert events. Additionally, real time comparison of a current public event to data analyses for past events, may be provided through the dashboard to determine whether the event has improved its performance in specific categories and overall. The aggregated data and analysis may be used by the data analysis system to generate predictive modeling of event satisfaction for future similar events (e.g., sporting events) or an ongoing live experience (e.g., amusement park), and allows the producer or manager of live events (e.g., event staff for a professional sports team) or ongoing entertainment experiences (e.g., management personnel for an amusement park) to tailor the event or experience to enhance those aspects of the event or experience that are best correlated with attendee/guest satisfaction.

The data analysis provided by the platform of the present invention is generated by the data analysis system. The data analysis system may comprise machine executable instructions that include novel predictive modeling techniques. In some embodiments the data analysis system includes predictive models that are produced utilizing variable importance analysis in order to determine the relative importance of specific aspects of an event or entertainment experience in order to determine the relative importance of those specific aspects and provide guidance to the producer/manager of the event or experience about which aspects should be enhanced and improved. Variable importance analysis may utilize a supervised learning model using Classification (e.g., at least one of Gradient Boosting Models (GBMs), Random Forests) and Regression (e.g., GBMs, Linear Regression, and Generalized Linear Models (GLMs). Survey data collected by the data analysis system may be used for training by the supervised learning model to generate a predictive model that applies analysis of correlations between data variables (e.g., survey questions and categories directed to aspects of an event or experience) and related scores (e.g., past survey data for the survey questions and categories) to provide actionable information to the event/experience producer about which aspects of the event or experience to address or change to enhance guest/attendee satisfaction. The predictive models may be updated over time based on analysis by the supervised learning model of a continuously expanding survey data set collected from multiple related events (e.g., multiple sports events held by a particular team) to determine which of the types of satisfaction data is associated with overall satisfaction with the event based on ordinal ranking data for particular category—e.g., satisfaction with concessions, satisfaction scores with featured entertainment, satisfaction score with parking and other access issues, etc. Once the data analysis system is trained for the particular kind event, the variable importance analysis is used in predictive modeling to determine which aspects of the new event or experience will best enhance the guest/attendee satisfaction with the event or entertainment experience. The supervised learning model may be incorporated into the data analysis system as machine-executable instructions in a machine learning module. The machine learning module may update the predictive model for a particular kind of event (e.g., basketball games of a particular professional team, amusement part general attendance experience, etc.) after each new data set is available, after a pre-determined amount of new data sets are available, after a specified period of time, or other selected criteria for updating the predictive model.

In some examples, partial dependency analysis may be used to isolate each variable (e.g., bathroom cleanliness, bathroom facility, bathroom location/availability, staff friendliness, etc.) and determine its influence on overall satisfaction scores, and train the data analysis system to recognize such data variable relationships. Variable importance analysis may show that bathroom cleanliness is highly influential on overall satisfaction scores, but it may be the case that its influence is a proxy for staff friendliness, thereby producing a variable importance analysis confounded by the subtle link between bathroom cleanliness and staff friendliness. Partial dependency analysis isolates particular variables in the data based on their correlation (e.g., a correlation over about 0.7) in order to determine whether there is dependency between two or more variables. As an example, data from different types of events and social experiences for particular sets of correlated variables (e.g., bathroom cleanliness conditions in combination with constant staff friendliness scores) can be analyzed statistically by the data analysis system and used to update the predictive modeling to include intervariable dependencies that are found in the data by the partial dependency analysis. The partial dependency analysis may be performed by machine-executable instructions that are incorporated into the machine learning module.

In some embodiments, unsupervised machine learning may be used to create contribute to the predictive models utilized by the data analysis system. Survey data collected by the data analysis system may be analyzed by an unsupervised machine learning model such as a K-Means or Hierarchical Clustering model, Principle Components Analysis (PCA) model, Exploratory Factor Analysis (EFA) model, Confirmation Factor Analysis (CFA) model, or Random Forest model. In some embodiments, the unsupervised machine learning models may be used as an alternative tool to the supervised learning models for generating predictive models for use in the data analysis system. In other embodiments, the analysis provided by unsupervised learning model may be used to train the supervised learning model discussed above. In some embodiments, the unsupervised learning model may be incorporated into the machine learning module. The predictive modeling is generated by the supervised learning model may be included in the machine-executable instructions of the data analysis system.

The predictive models incorporated into the data analysis system are updated overtime as new survey data is collected from guest/attendees by the data analysis system. The accuracy of the predictive models can also be further adjusted by testing the predictive effectiveness of the predictive models produced by the machine learning model (including the variable importance, and, in some embodiments, the partial dependency analysis). The predictive models may be tested for their predictive power against an actual data survey outcome that has not yet been incorporated into the supervised learning model. For example, a predictive model built using data from four basketball games hosted at a venue may be tested for its predictive accuracy against the actual survey data collected from another basketball game that has not yet been incorporated into the supervised learning model. A data shift metric module incorporated into the machine-executable instructions of the data analysis system may be used to test the accuracy of the predictive model. The data shift metric model may be used to test the accuracy of the predictive model with each new related event (e.g., each successive basketball game), after a pre-determined amount of new data sets are available, after a specified period of time, or other selected criteria for applying the data shift metric model.

The data shift metric module may utilize error measurement techniques, including one or more of lift charts, root mean squared error (RMSE), and area-under-the-curve/receiver-operating-characteristic (AUC/ROC). If the error measures significantly change over time (e.g., by a predetermined RMSE score of greater than about 0.15), the data metric model may determine that the new data is no longer has a sufficiently significant connection between predictive model and target details. The implications can include a guest/attendee demographics have materially changed, guest/attendee culture and preferences have materially changed (e.g., bathroom cleanliness has become of paramount importance after a pandemic), or guest/attendee experiences has materially changed (e.g. retraining staff on cleaning procedures has led to bathroom cleanliness improving).

The predictive models of the present invention are repeatedly updated over time to both increase the accuracy of the predictive model and to determine shifts in the guest/attendee preferences over time. Thus, the data analysis system of the present invention may be used by the event/experience producer to stay informed and updated on overall fan satisfaction for the particular kind of event and the shifts in guest/attendee preferences, thereby preventing the event or experience to languish into a unpopular or passé status.

The data analysis system may include an artificial intelligence (AI) language analysis module operable to analyze features the attendee's free form language that indicate sentiment (e.g., slang, acronyms, tone, abbreviations, etc.) in the narrative responses to survey questions. The artificial intelligence analysis module may conduct analysis of unstructured information in the attendees' free form responses that assign values to positive, negative, or neutral text, thereby converting the attendees' language into a dataset having assigned values in pre-determined categories. The sentiment analysis values for each question and each category of question may be collected and statistically analyzed to provide an overall attendee satisfaction score for each question and category, providing attendee opinion data for the aspects of the event addressed in the free form response section of the survey. The AI language analysis may be based on natural language processing (NLP) or computational linguistics. The text of an open-ended attendee survey response may be analyzed using NLP to ascertain consumer-identified topics or issues that relate to a survey category and analyze the attendee sentiment relating to that survey category based on the language used by the attendee in their narrative response (e.g., analyzing the language in the response for emotive language, such as positive and negative adjectives, positive and negative slang or abbreviations, the nouns to which the positive and negative language elements refer [e.g., the food, staff service, etc.], and other aspects of the language used in the attendee's responses).

The AI language analysis module may also conduct weighting analysis of responses, assigning more weight to answers that include a pre-determined volume of characters, indicating either a lack of engagement or importance (e.g., when answers are below a minimum character threshold), or a high level of engagement or importance (e.g., when answers are above a minimum character threshold).

The AI language analysis module, ordinal, nominal, and/or other survey response data may be analyzed to identify specific issues occurring at the event or experience in real time. For example, certain issues or facility conditions at a public event may be addressed in real time, such as malfunctioning equipment or facilities, lack of soap or sanitizer in restrooms, or other issues that need to be addressed immediately to ensure an enjoyable experience for the attendees (e.g., a flooding bathroom, a dysfunctional portion of a PA system, inebriated attendees, etc.). The system modules may include a critical “at risk” issues module that identifies specific types of critical issues that are addressable during the event. These critical issues may be determined by pre-existing categories and questions within the survey that are coded as critical (e.g., lavatory malfunction, PA malfunction, etc.) and thus certain survey responses may automatically raise “at risk” issue based on, e.g., a nominal survey response indicating (e.g., a yes or no answer option in the survey regarding whether the PA system is functioning properly).

The AI language analysis module may identify critical issues raised in narrative answers provided to open-ended questions in the survey by identifying terms associated with critical issues. For example, the AI may analyze the narrative responses in the survey data for nouns (e.g., nouns—speaker, sound system, PA system, and grammatical variations thereof) adjectives (e.g., malfunctioning and/or broken and grammatical variations thereof), and other word forms associated with pre-determined critical issues and generate a report of a critical issue for the critical issue module of the system dashboard.

The critical issue may be localized to the attendee location from which the survey responses were submitted and the data analysis system may correlate the metadata associated with the relevant survey responses (e.g., the location of the mobile computing device(s) reporting the issue on through the survey responses, the seat or location assignment for the attendee submitting the survey responses, the time of the submission of the relevant survey responses, etc.) with the at risk issue raised to determine the likely location of the at risk issue. The event staff or producer may then respond to such at risk issues in real time. The alert and flagging of these critical issues may delivered to the staff and producer/manager through the system (e.g., via the dashboard and/or staff mobile application). The event/experience producer may also contact the attendee(s) who raised the issue through electronic communication (e.g., a text, push notification, or other electronic communication) to the mobile computing device(s) used to submit the survey responses. In some embodiments, the system may be operable to generate automated text, push notifications, or other electronic communications to staff to identify the critical issue. In some embodiments, the system may be operable to generate automated text, push notifications, or other electronic communications to attendee(s) who raised the relevant critical issue to inform the attendee that the critical issue is being addressed by event staff. The system may also track and record instances of critical issues at an event and correlations between such at risk issues and attendee satisfaction scores overtime to determine which categories of critical issues are more impactful on attendees' subjective satisfaction with an event and adjust the critical categories and responses to such at risk issues accordingly.

The survey system my further comprise a commercial module operable to utilize the quantitative and/or linguistic analysis of a particular survey or set of surveys, determine an association between an event aspect and attendee demographics, and to provide suggestions for optimally soliciting the particular demographic. The survey system may also determine the best way to incentivize a guest, depending on their profile, to take a survey or increase expenditures. For example, the system may automatically associate a frequent guest with stadium events, and suggest incentivizing the guest to complete a survey by providing a discount on their following visit. As a further example, group attendance may be determined by one or more of natural language survey responses, multiple choice response regarding purpose of attendance and group attendance, ticket serial number and correlation of ticket serial number with a group purchase of tickets, and/or other information. The system may then associate an event aspect or offering that correlate with group attendance (e.g., group discounts offered by vendors in the event and coded into the system as a “group offer”), and to provide correlated solicitations for group attendees (e.g., a discount on an available box seats upgrade at a sporting event, a discount on dining to fill an available banquet room reservation in an amusement park).

A flow chart of a survey data collection and analysis process according to the present invention is provided as FIG. 10 hereto. The flow chart is exemplary and provided only to illustrate an embodiment of the presently disclosed processes, and in no way limits the scope of the present invention.

The processes described herein may be conducted using a computing system and network allowing for the interconnection of one or more general purpose computer or servers operable to execute computer readable code and launch a survey to receive data from mobile computing devices through which survey responses may be provided.

The survey data analysis platform may be deployed in one or more sets of machine executable instructions tangibly embodied on a non-transitory computer-readable storage medium and including executable code that may include instructions to receive survey data from surveys submitted through an electronic medium (e.g., a web portal, mobile application, etc.), where the survey data. The executable code may include instructions to receive one or more completed or partially completed surveys, where each completed or partially completed survey may include survey results providing one or more answers to the plurality of questions. The executable code may include instructions to statistically analyze the quantitative survey data (e.g., scale ranking answers) to determine the statistical characteristics of the data (e.g., average, median, standard deviations, distribution of the data, etc.) and perform analysis that provides weighting to particular questions and categories of questions with a priority of importance of the questions and categories relative to overall attendee experience based on the survey responses. The executable code may also provide an overall satisfaction score for each completed or partially completed survey and the attendees in general based on the survey analysis. The survey data, calculated question and category weights, satisfaction scores, and other analysis may be stored in a database on a non-transitory computer-readable storage medium.

In some embodiments, the one or more sets of machine executable instructions may be stored in a memory of and executed by a computing system comprising at least one general purpose computer or server having at least one processor (Central Processing Unit [CPU]) operable to execute machine executable instructions for the survey data collection and analysis processes of the present invention. The system may further include other components that are well known to one of ordinary skill in the art needed for the function of the general purpose computer (e.g., a power supply, hard drive, random access memory (RAM), internet connection devices and software, etc.). The computing system may include a logic unit (e.g., a package of executable instructions saved on the hard drive and executable by the processor) for receiving and processing the survey data that includes one or more sets of executable instructions for receiving survey data through a web portal or mobile application that is in electronic communication with the survey collection and analysis system through various electronic communication means, including WiFi, WLAN, WiMax, 3G/4G/5G cellular, and/or other wired or wireless data communication connections. The computing system may also include a database stored on a non-transitory computer readable storage medium, the database being operable to store the collected survey data. The computing system may be in electronic communication with a graphical user interface operable to display a data analysis report format having one or more modules (e.g., a dashboard) viewable by an event/experience producer.

Generally, the survey data analysis platform may collect and process survey data from an external source (e.g., through a web portal or a mobile application in electronic communication with said system) in order to generate an updatable and real time attendee satisfaction report during a pre-determined timeframe (e.g., during the event) to the graphic user interface display. The survey data analysis platform may also include an event staff mobile application that provides real time data to multiple event staff members during an event or operational to the graphic user interface display of a mobile computing device, in order to alert staff to issues that require redress during the event or operational hours of the entertainment experience.

The survey data may include attendee responses to quantitative survey questions (e.g., ranking various features and services of an event on a scale), metadata regarding attendee respondents and their survey responses (e.g., demographic data, time and place of survey response, etc.), and narrative form responses to open-ended survey questions. As the survey data is collected the data analysis system may analyze the survey data in real time, providing generalized scores for each question and question category, analysis of question and/or category priority, and/or analysis of open-ended survey questions through the graphical user interface to allow the event producer to evaluate the performance of various features, aspects, and services of the event in real time. The data analysis system may also store the survey data and analysis output in a memory of the system. For example, during the event, the system may calculate a general satisfaction score for each submitted survey, satisfaction score for each survey category (e.g., each relating to a specific aspect of the event, such as concessions, staff services, parking, event performances, etc.), and generalized satisfaction scores taking into account response from all attendees submitting completed or partially completed surveys.

The present invention provides a survey data analysis platform and methods for collecting, analyzing, and delivering processed and actionable survey data to event producers in real time. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

### BRIEF DESCRIPTION OF THE DRAWING

FIG. 1 shows a simplified flow chart of the survey data collection and analysis process.

FIG. 2 shows a view of an event where the survey data collection system is in use connecting an audience via a machine code.

FIG. 3 shows a view of a dashboard module with a summary score as well as most significant categories determined by the analysis performed.

FIG. 4 shows a of a dashboard module with automated responses that are a synopsis of fan responses as well as filtered guest responses; both of which are provided by the set of machine executable instructions

FIG. 5 shows a view of a dashboard module that indicates the most significant elements determined by the analysis performed.

FIG. 6 shows a view of a critical risk module that indicates critical risks detected in survey data by the set of machine executable instructions.

FIG. 7 shows a view of other dashboard modules associated with attendee information.

FIG. 8 shows a view of other dashboard modules associated with data from previous events.

FIG. 9 shows a view of a commercial dashboard module with solicitations suggestions.

FIG. 10 shows a view of a commercial dashboard module with demographic analysis.

FIG. 11A shows a view of a commercial dashboard module with critical issue notifications.

FIG. 11B shows a view of a feedback request sent to a guest mobile-computing device.

FIG. 12 shows a flow chart of a survey data collection and analysis process according to the present invention.

FIG. 13 shows a flow chart of a data analysis system process according to the present invention.

### DETAILED DESCRIPTION OF THE DRAWINGS

Reference will now be made in detail to certain embodiments of the invention, examples of which are illustrated in the accompanying drawings. While the invention will be described in reference to these figures and certain implementations and examples of the embodiments, it will be understood that such implementations and examples are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. References to various features of the “present invention” throughout this document do not mean that all claimed embodiments or methods must include the referenced features. It will be apparent to one skilled in the art that the present invention may be practiced without these specific details or features.

Reference will be made to the exemplary illustrations in the accompanying drawings, and like reference characters may be used to designate like or corresponding parts throughout the several views of the drawings.

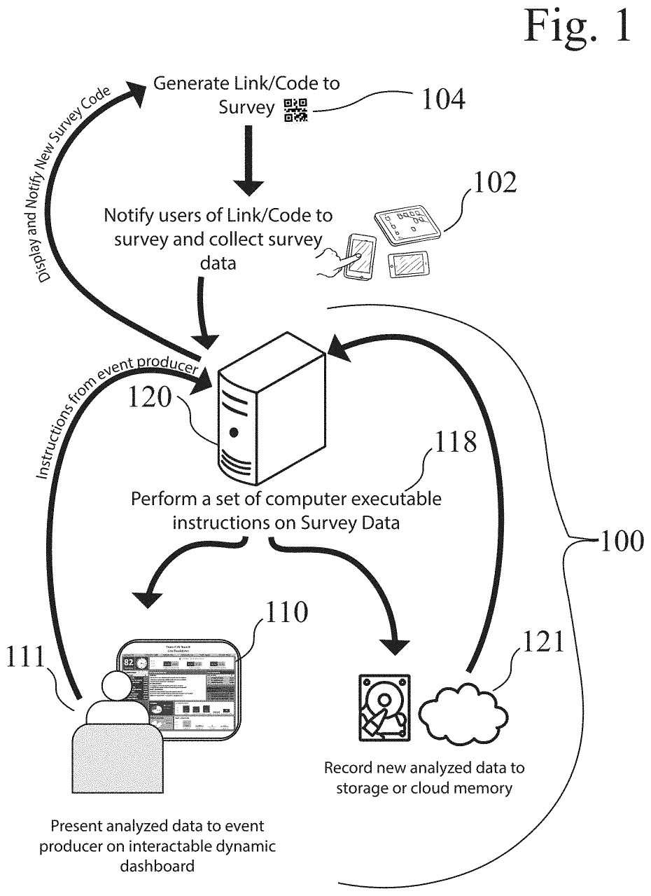

As shown in FIGS. 1, the survey collection and analysis system 100 may be configured to deliver customer surveys to the attendees 101 of an event or social experience. The attendees may be provided the survey through a mobile computing devices 102 (e.g., a smart phone, smart watch, tablet, or other mobile computing device) through a web-based portal or an application downloaded onto the attendee's mobile computing device. In some embodiments, the survey data collection and analysis system 100 may include one or more general purpose computer(s) and/or server(s) 120 having at least one processor (Central Processing Unit [CPU]) operable to execute machine executable instructions for the survey data collection and analysis processes of the present invention. The system may further include other components that are well known to one of ordinary skill in the art needed for the function of the general purpose computer 120 (e.g., a power supply, hard drive, random access memory (RAM), internet connection devices and software, etc.). The system may include a logic unit (e.g., a package of executable instructions saved on the hard drive and executable by the processor), as described in step 302, for receiving and processing the survey data that includes one or more sets of executable instructions for receiving survey data through a web portal or mobile application that is in electronic communication 117 with the survey collection and analysis system through various electronic communication means, including WiFi, WLAN, WiMax, 3G/4G/5G cellular, and/or other wired or wireless data communication connections. The system may also include a database stored on a non-transitory computer readable storage medium 121, the database being operable to store the collected survey data. The system may be in electronic communication with a graphical user interface operable to display 110 a data analysis report format having one or more modules 200 (e.g., a dashboard) viewable by an event producer 110.

Generally, the system may collect and process survey data from an external source (e.g., through a web portal or a mobile application in electronic communication with said system) in order to generate an updatable and real time attendee satisfaction report during a pre-determined timeframe (e.g., during the event) to the graphic user interface display.

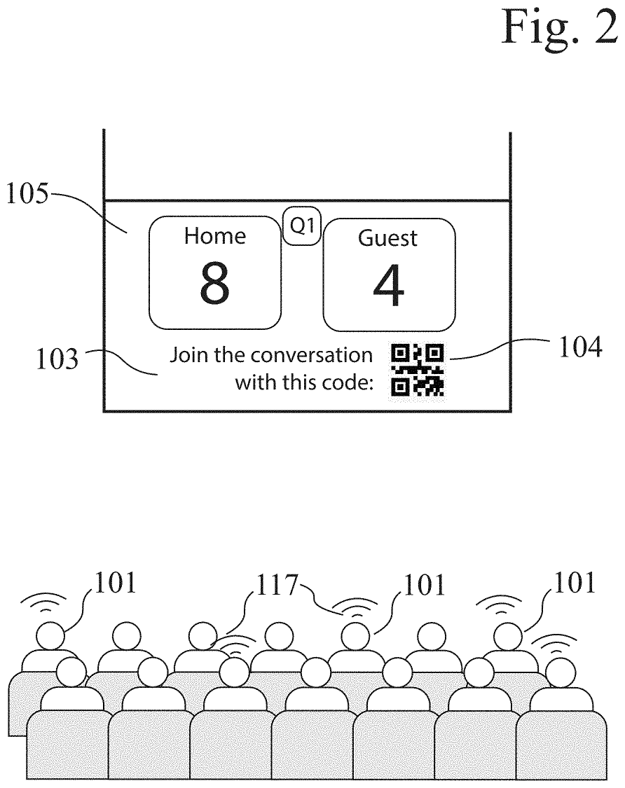

As shown in FIG. 2, the attendees 101 may be prompted to respond to a survey during the event by several prompts. In some examples, a prompting message 103 and a corresponding machine-readable code 104 (e.g., an optical label such as a QR code) may be presented onsite at the event on electronic media boards 105 (e.g., a scoreboard, or other media) to allow the attendees capture the machine-readable code 104 with a mobile-computing device and be directed to the survey through a webportal or mobile application. The machine-readable code 104 may be presented through various means at the event, such as a large digital screen 105 (e.g., a scoreboard, or large digital display over a stage, etc.), smaller digital screens mounted in a venue, digital or tangible posters or signage at the event, or other means. In some embodiments, attendees may be prompted by notifications sent to their mobile computing devices 102 (e.g., text messages, push notifications, etc.) providing a link to the survey. The notifications or machine code may also prompt the attendee to download a mobile application (e.g., associated with the event, the entertainer(s) present at the event, the event producer, or others), notify the attendee about details or schedule of the event, and/or provide safety and emergency information. In further examples, a notification of a survey and a link to the survey may be sent by the survey collection and analysis system 100 via text message or via a message sent via a wireless network within the venue (e.g., a WiFi system) through a wireless connection 117. The connection 117 to the survey collection and analysis system, although shown as a symbol denoting wireless electronic communication, may be any form of electronic communication, including wired communication via ethernet or USB.

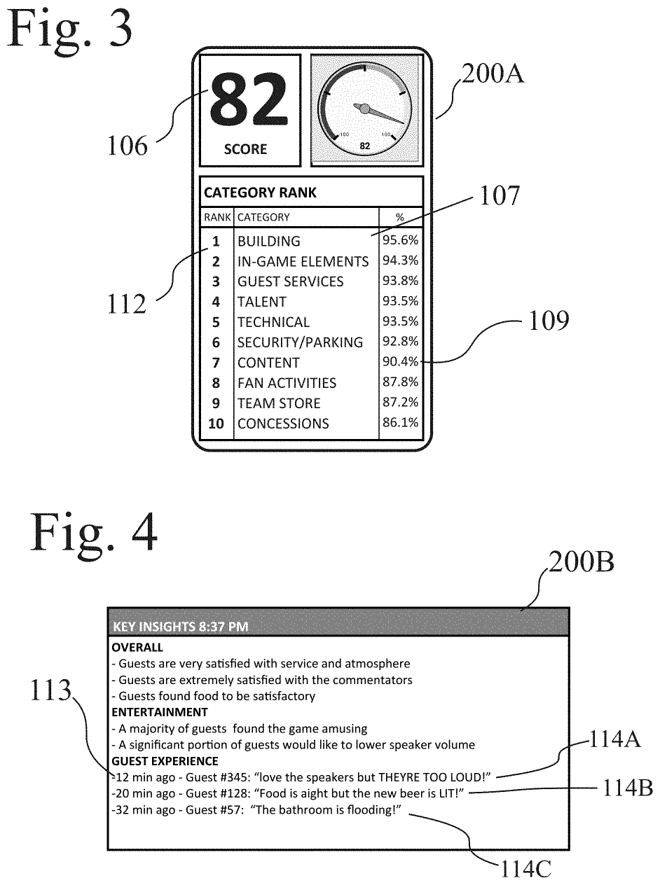

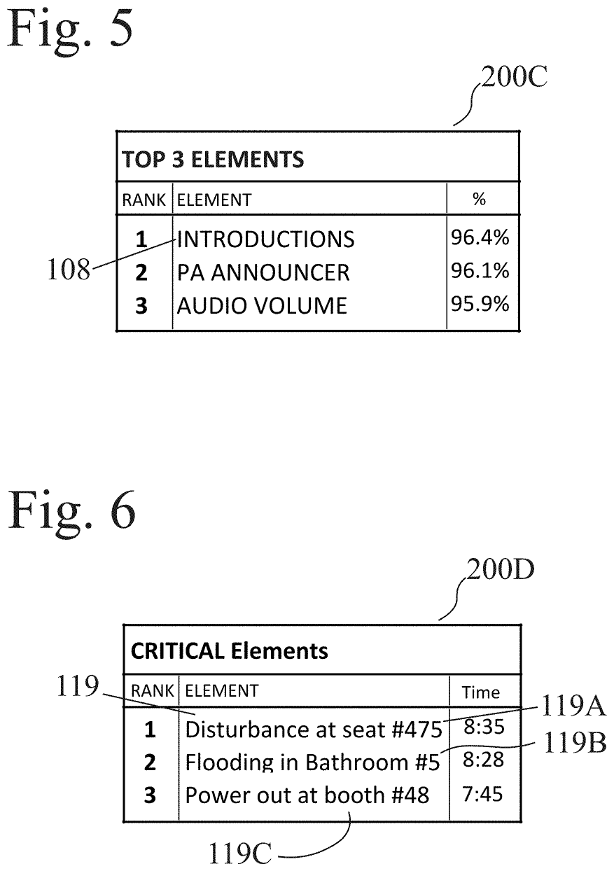

The attendee 101 may respond to the survey through the web-portal or mobile application, answering one or more of the survey questions which are then passed into the data collection and analysis process conducted by a set of machine executable instructions 118 that analyze the survey answers, the attendee profile, various metadata relating to the time, location, and activity of the attendee at the time their survey responses were submitted. As shown on FIGS. 3-9, the analysis of the survey questions and categories may be organized by the machine executable instructions into modules 200 for presentation to an event/social experience producer 111, such that the data analysis conveys useful and actionable information. The machine executable instructions may generate an overall satisfaction score 106 for the event, and analyses of each individual survey questions and/or survey question category to determine attendee satisfaction with various aspects of the event (see reference numbers 107 in FIGS. 5 and 108 in FIG. 6) and the relative importance of various aspects of the event. Such event aspects may include concessions, lavatories, venue comfort and convenience (e.g., with respect to seating, stairs, views of the stage, field or other focal points, parking convenience, etc.), venue staff performance, entertainment value of the event performances (e.g., sports competition, concert performers, stage performers such actors and comedians, etc.). Survey category scores 109 may be individually provided to the event producer 111, along with relative priority or weighting values of the category with respect to the calculated importance attendees attribute to each category.

As shown in FIGS. 1, the data analysis may be provided to the event/social experience producer 111 through a dynamic dashboard 110 that presents the data analysis through a graphical user interface. The graphical user interface displayed on the dynamic dashboard 110, may also be accessed through a remote client, enabling the producer 111 to interact with the dashboard without having to be physically present (e.g., using a mobile-computing device, computer, or other appropriate device). As demonstrated in FIGS. 3-9, the dynamic dashboard may include several dashboard modules 200, each presenting different forms of survey data analysis, including a general satisfaction 106 score calculated from the survey data provided by attendees; prioritization analysis of each category 112 to inform the event producer as to which survey categories are the most important to the overall experience of the attendees 101; survey response results for particular categories of attendees (as shown in modules 200E, 200F, and 200H) based on various criteria such as location of attendee (e.g., assigned seat or section, etc.), age, gender, ethnic group, the people with whom the person attended the event (e.g., alone, with friends, with family, with significant other, with work colleagues, etc.), ticket category (e.g., season ticket holder vs. single game ticket), price paid or for attendee ticket, and/or other profile data collected through the survey or otherwise; time of survey response 113 relative to event (e.g., was it provided at the time of the event or later); and priority ranking of specific offerings of the event within a category (e.g., within the concessions category, priority ranking of concession service, food quality, options, wait time, value/cost, and convenience, such as proximity to seat assignment). The data for each of these categories can be received on a continuous basis during the event and incorporated into the raw data set for the survey system to analyze, and the data analysis may be updated in real time during the event resulting in continuous or intermittent changes in the data analysis provided through the dashboard modules 200 in the dynamic dashboard 110 accessible to the event producer 111.

The real-time data analysis provided through the survey data platform dashboard 110 may allow an event producer 111 to review the data analysis during the event, and make changes that are responsive to attendees' concerns and preferences. FIG. 4, for example, shows a module 200B that highlights attendee survey data responses 114A, 114B, and 114C that indicate qualitative insights to provide specific direction and information on quantitative feedback and categorical responses that have been computed. For example, if scores for audio are low, qualitative comments provide detail that it is the volume being too loud that warranted (vs. being too soft or unclear). In response, the event producer 111 may then adjust the volume levels of the venue sound system at an appropriate opportunity to provide a better overall attendee experience.

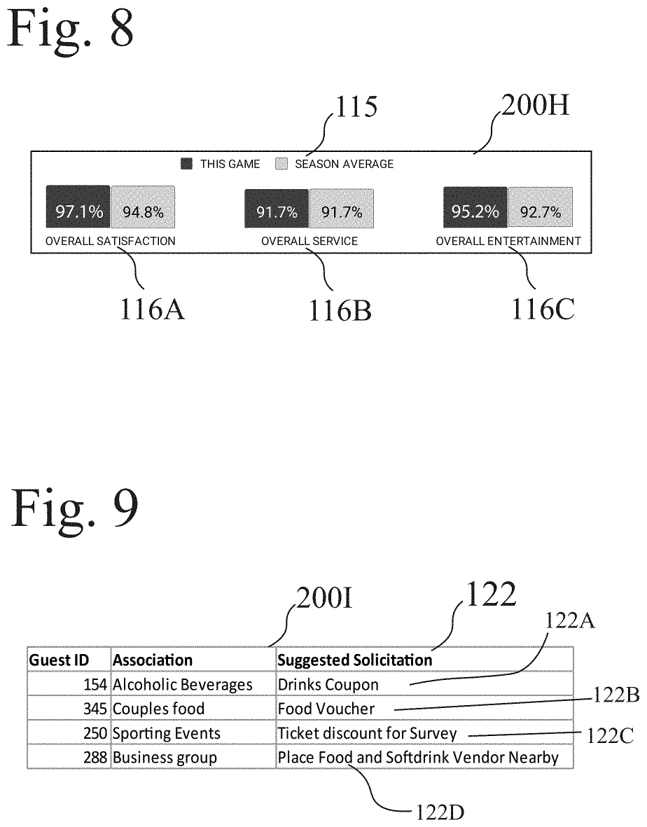

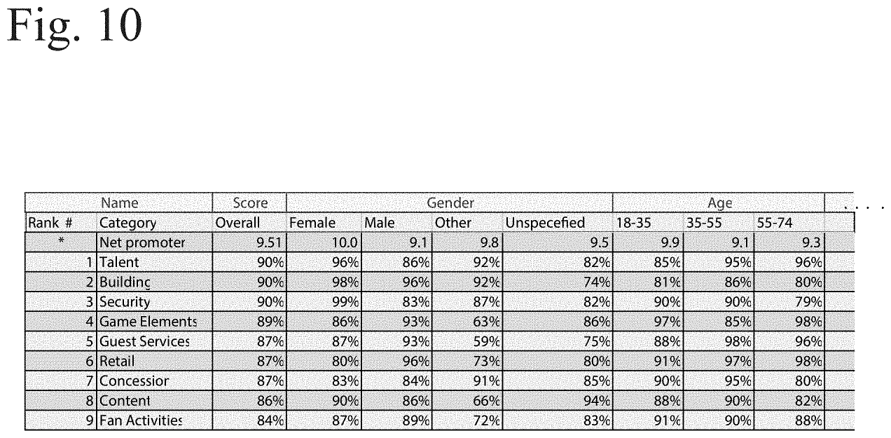

As exemplified by FIG. 8, analysis of the survey data may be conducted by analysis of accumulated data 115 from multiple events conducted by the event producer to provide a more robust data set for each survey question and each survey category of data received through the survey data gathering process. The survey data analysis system may also analyze the data between events 116, also described in FIG. 10 step 306D, to determine whether any quantitative changes in the survey data have occurred and whether any such changes in the data may be correlated with changes to services and offerings of a particular event or any differences between events. FIG. 8, for example, shows a process performed by the system 100. Survey data may be taken throughout the season of a sporting event to determine how satisfaction, service, and entertainment from the current event compare. Additionally, real time comparison of a current public event to data analyses for past events, may be provided through the dashboard 110 to determine whether the event has improved its performance in specific categories and overall.

As shown in FIG. 9, the survey system may further comprise a module 2001 operable to utilize the quantitative and/or linguistic analysis of a particular survey or set of surveys, determine an association between an event aspect and attendees, 101 and to provide suggestions for optimally soliciting attendees. For example, if the event was hosting a company outing, the system may automatically detect an influx of surveys, associate them as a business group, and suggest sending a vendor nearby 122D. The survey system may also determine the best way to incentivize a guest, depending on their profile, to take a survey or increase expenditures. For example, the system may automatically associate a frequent guest with stadium events, and suggest incentivizing the guest to complete a survey by providing a discount on their following visit 122C.

FIG. 10 provides a view of an exemplary dashboard display of demographic variance analysis of specific demographic categories to illustrate to clients how demographics influence guest preferences and aggregate ratings. Demographics, such as age, gender, group (e.g., family group attending), price paid per ticket, and other data, are analyzed by the system from survey data and resulting calculated scores from data by specific demographic categories are displayed in detailed charts. The system 100 may conduct demographic analysis on selected demographic categories in order to provide analysis relevant to specific types of events and/or social experiences. The system dashboard may allow the event or social experience producer to isolate specific demographic analysis applicable to an upcoming event. The system may also be operable to generate a predictive model of what aspects of the event (e.g., parking, ease of access, concessions, etc.) the likely attendees of the event will most value. This predictive modeling provides guidance to the event producer as to what aspects of the event to focus on and enhance to optimize guest satisfaction with the particular event.

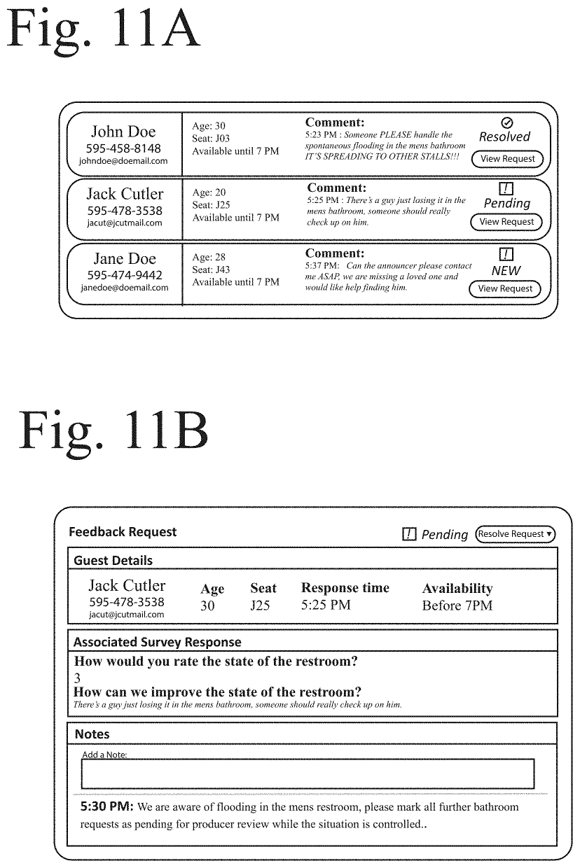

FIGS. 11A shows a module operable to alert the event or social experience producer or staff that guest(s) are having an unsatisfactory experience. The system 100 may be operable to trigger alerts and notifications that go directly to the event or social experience producer via the dashboard and/or staff via the staff web application on computers or mobile devices so they may address in real time and provide elevated customer service. The guest may submit a complaint form via the web or mobile application or webportal that provides located, time, guest contact, and issue identification data and the system 100 may push the complaint form to the producer and/or staff, allowing them to address the issue in real time. In some embodiments, the system 100 may receive and analyze survey data that provides ordinal rankings for a specific aspect of the venue (e.g., lavatory condition), indicate key words or phrases in their open-ended responses that generate an alert (e.g., “filthy” in the lavatory category), or otherwise indicates a specific issue. The alert and flagging of these issues may be delivered to the staff and producer/manager of the event or social experience with an indication of the issue (e.g., lavatory maintenance), the issue location, and suggested action item to remedy the situation. The data associated with the complaint notification may indicate the location of the guest(s) submitting the complaint to the producer and/or staff of the event or social experience. In some embodiments, the location of the guest(s) may be determined by location data based on geolocation data collected from the guests' mobile computing devices through the web application, WiFi probe analysis to determine which WiFi access point to which the guests' mobile computing devices are connected, data provided by the guest (e.g., guest locating a pin on a digital map), or by other appropriate methods. In some embodiments, the system may send alert notifications to event staff near the location of the guest(s) providing the alert, who may be identified by geolocation data collected from the staff mobile computing devices through the staff mobile applications, WiFi probe analysis to determine which WiFi access point to which the guests' mobile computing devices are connected, or by other appropriate methods. Once the issue is addressed, the staff attending to the issue may utilize a command within the staff mobile application or through the dashboard that the issue is presently being addressed (“pending”), and has been fully addressed (“resolved”).

FIG. 11B shows a follow up notification and request for feedback that may be provided by the system 100 to the guest(s), with or without manual intervention or push from staff members at the event, with the aim of providing the status of a particular issue, providing service recovery (automated or staff-led) and allowing the guest(s) to respond and provide additional information or concerns. Such notifications may be sent to the guest(s) regardless of whether the issue was the result of a specific request for assistance by a guest, or was the result of survey analysis that indicated the presence of a specific issue at the venue.

A flow chart of a survey data collection and analysis process according to the present invention is provided in steps as FIG. 10. The flow charts are exemplary and provided only to illustrate an embodiment of the presently disclosed processes, and in no way limits the scope of the present invention.

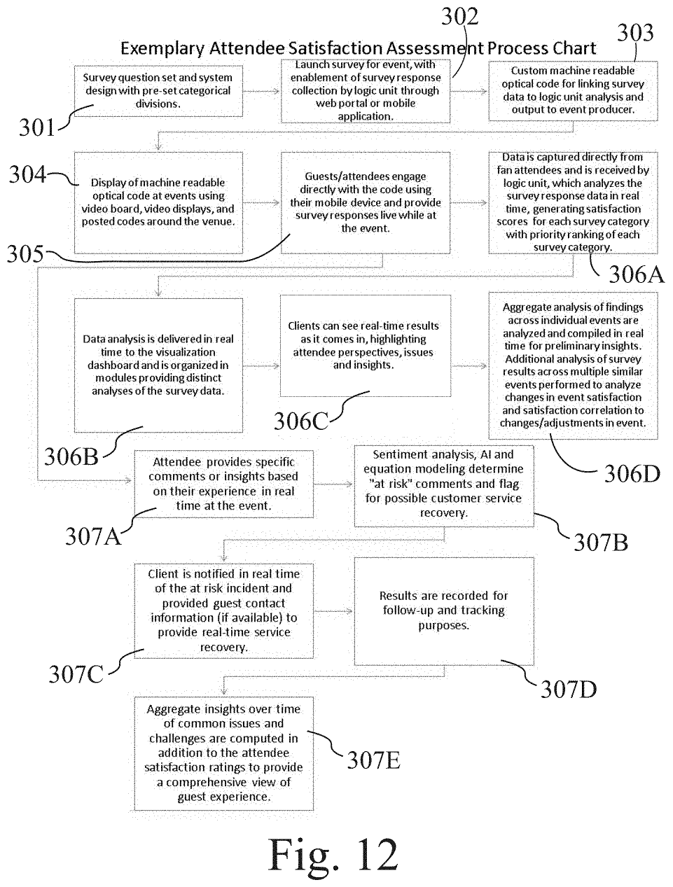

The processes described and illustrated above may be conducted using a computing system and network as shown in FIG. 2, allowing for the interconnection of one or more general purpose computers or servers 120 operable to execute computer readable code (e.g., executable instructions) to launch a survey to guests in a venue. As indicated in step 301 in FIG. 12, the survey may be a pre-determined set of questions that are pre-sorted into pre-determined categories that allow for individualized analysis of certain aspects of the event, such as the hygiene facilities, the concessions, ease and convenience of attending the event (e.g., traffic, parking, etc.), crowd management and ease of access to various areas of the venue, the quality of the entertainment, vendors, or other featured aspects of an event held at the venue (e.g., the quality of and satisfaction with the music performed at a concert, the quality of and satisfaction with vendors at a trade show, the quality of and satisfaction with the play of a basketball game, etc.), and other aspects of the venue and hosted event. The survey may use validated index sets to verify question validity and reliability in the raw data so computational insights are accurate.

As shown in steps 302-305, the survey may be launched by the computer(s) 120 directly to mobile computing devices 102 through a mobile application downloaded onto the mobile-computing devices 102. The system may include one or more sets of computer 120 executable instructions tangibly embodied on a non-transitory computer-readable storage medium 121 and including executable code that, when executed, may include instructions to receive survey data from surveys submitted through an electronic medium. The surveys may be delivered to attendees through push notification to mobile-computing devices 102 connected to venue WiFi providing a link to download the web application providing the survey or a link to a webportal through which the survey may be taken and submitted, or through a unique machine-readable code 104 generated by computer(s) 120 (e.g., a matrix code, such as a QR code) that may be posted on traditional signage and/or on electronic media boards, televisions, video monitors, and other electronic media in the venue. For example, the attendees may be provided with a link via a push notification to their mobile devices 102, allowing them to touch the link to open the web portal to the survey. In a further example, the machine-readable code generated by computer(s) 120 may be prominently displayed on electronic media boards in the venue (e.g., a scoreboard in an arena, advertising display boards at the entrance to the arena or within the arena, etc.) and the attendees may be prompted to use their camera application in their mobile-computing devices 102 to capture the machine-readable code, which will (1) redirect the guest to the web application with specific questions pertaining to the event, and/or (2) open the web or mobile application on their mobile-computing devices 102.

As shown in Step 305, the attendees who choose to participate, enter their responses to all or a portion of the survey inquiries, which may include quantitative (e.g., ranking) data and qualitative data (e.g., selecting answers for a multiple-choice question or open form narrative answers), and submit them through the webportal. The computer(s) 120 may then receive data through the webportal or mobile application from mobile computing devices through which survey responses may be provided, as described in steps 305-306A. The executable code may include instructions to receive one or more completed or partially completed surveys, where each completed or partially completed survey may include survey results providing one or more answers to the plurality of questions. The system also automatically determines time of completion and omits responses that do not meet the threshold for minimum time to comprehend vs volume of items being asked to eliminate fake data or data that guests input without reading questions (ex. Just select all ls to get the incentive but don't actually read any of the items which would invalidate calculated results if included).

As described in step 306A, the executable code may include instructions to statistically analyze the quantitative survey data (e.g., scale ranking answers) to determine the statistical characteristics of the data (e.g., average, median, standard deviations, distribution of the data, z-scores, etc.) and perform analysis (via automated computational methods that can include decision tree models, gradient boosting modeling and random forest modeling) that provides weighting to particular questions and categories of questions that provide a priority of importance of the questions and categories relative to overall attendee experience. As the survey data is collected, the logic unit may analyze the survey data in real time, providing generalized scores for each question and question category, analysis of question and/or category priority, and/or analysis of open-ended survey questions through the graphical user interface to allow the event producer to evaluate the performance of various features, aspects, and services of the event in real time. The executable code may also provide an overall satisfaction score (see, e.g., FIG. 4, reference no. 106) for each survey question category completed or partially completed survey, and an overall attendee satisfaction score for the event based on the survey analysis. The survey data, calculated question and category weights, satisfaction scores, and other analysis may be stored in a database 121 on a non-transitory computer-readable storage medium.

In some embodiments, the statistical analysis, step 306A, may comprise ranking quantitative questions and/or question categories into empirical percentiles. For example, if the ranks were set up as letter grades A, B, C, and D, wherein the proportion of each rank was 5%, 50%, 40% and 5%, where the top 5% of ratings given an ‘A’ ranking, the following 50% are given a ‘B’ ranking, the following 40% a ‘C’ ranking, and the lowest 5% a ‘D’ ranking. The statistical analysis may comprise calculating the z-scores of quantitative questions and/or question categories, and ranking them proportionally by setting the z-score of each desired proportion to be the cutoff. For example, if the ranks were decided to be lettered grades A, B, C, and D, wherein the proportion of each rank was 5%, 50%, 40% and 5%, the z-scores that mark the cutoff between each rank can be determined from a normal distribution table to be approximately −1.645 (D/C), −0.126 (C/B), and 1.645 (B/A). For a data set that has a rating average of 4.5 and a standard deviation of 0.15, these z-score cutoffs would translate to 4.253 (D/C), 4.481 (C/B), and 4.747 (B/A). The statistical analysis may further comprise combining the cutoffs determined from the empirical percentile method and z-score method into a weighted average cutoff, wherein the weighing factor may be determined from the Pearson correlation coefficient of the data. For example, if the Pearson correlation coefficient is calculated to be 0, it may be determined that the z-score cutoff and the empirical percentile cutoff should carry the exact same weight. As another example, if the Pearson correlation coefficient is determined to be 1, meaning the data completely follows normal distribution, it may be decided that the z-score cutoff should carry all the weight.

Once the statistical analysis is performed automatically by the system, the data can be delivered in real time to the “client” (e.g., the event producer, or other person or group of persons monitoring the event production and management) in step 306B. The survey data may be collected and periodically analyzed in an ongoing basis throughout the event and after the event, with the updated data and analysis being delivered to the client dashboard 110 as it is produced. The dynamic dashboard 110 may include several dashboard modules as shown in FIGS. 3-10, each presenting different forms of survey data analysis, including a general satisfaction scores for each survey category, raw response volumes to each survey question and survey category; prioritization analysis of each category to inform the event staff or social experience producer as to which survey categories are the most important to the overall experience of the attendees; survey response results for particular categories of attendees based on various criteria such as location of attendee (e.g., assigned seat or section, etc.), age, gender, ethnic group, the people with whom the person attended the event (e.g., alone, with friends, with family, with significant other, with work colleagues, etc), ticket category (e.g., season ticket holder vs. single game ticket), price paid or for attendee ticket, and/or other profile data collected through the survey or otherwise; time of survey response relative to event; and priority ranking of specific offerings of the event within a category. The data may be reanalyzed and redelivered on a continuous basis or upon receipt of incremental amounts of survey data. For example, the data may be reanalyzed in the aggregate upon receiving an additional tranche of data from a pre-determined minimum number of additional attendees (e.g., 10 additional survey responses, 20 additional survey responses, 30 additional survey responses, etc.). The graphical user interface displayed on the dynamic dashboard, may also be accessed through a remote client, enabling the producer to interact with the dashboard without having to be physically present.

The real-time data analysis provided through the survey data platform dashboard may allow an event producer to review the data analysis during the event, and make changes that are responsive to attendees' concerns and preferences, as indicated in step 306C. For example, if the event is a concert, and the attendee survey data responses indicate that a significant number of attendees feel the sound system is too loud, the event producer may adjust the volume levels of the venue sound system at an appropriate opportunity to provide a better overall attendee experience.

In step 306D, analysis of the survey data may be conducted by analysis of accumulated data from multiple events conducted by the event producer to provide a more robust data set for each survey question and each survey category of data received through the survey data gathering process. The survey data analysis system may also analyze the data between events to determine whether any quantitative changes in the survey data have occurred and whether any such changes in the data may be correlated with changes to a particular event or any differences between events. Predictive modeling and aggregate analysis may be conducted on raw data to enhance findings and provide additional insights, prioritization and valuation to clients. The comparisons between real time data of a current public event to data analyses for past events, may be provided through the dashboard to determine whether the event has improved its performance in specific categories and overall. This allows event producer to evaluate a change made between events in real time and determine its efficacy. For example, if public address system volume has been reduced from one event in response to survey data from a prior event, and the survey data form attendees of the current event provides a stronger indication of dissatisfaction, the event producer may adjust the public address system volume accordingly during the current event. They can also use the aggregate information over time to determine that small adjustments are insufficient, audio clarity and volume are very important to guests and the best satisfaction is investing in a system upgrade to reach an appropriate level of quality that minor adjustments were unable to attain and whereas data shows fans remained unsatisfied due to inaudible clarity.

As described in step 307A, the survey system may include an artificial intelligence (AI) language analysis module operable to analyze features the attendee's free form language that indicate sentiment (e.g., slang, acronyms, tone, abbreviations, etc.) in the narrative responses 114 to survey questions. The artificial intelligence analysis module may conduct analysis of unstructured information in the attendees' free form responses 114 that assign values to positive, negative, or neutral text, thereby converting the attendees' language into a dataset having assigned values in pre-determined categories. The sentiment analysis values for each question and each category of question may be collected and statistically analyzed to provide an overall attendee satisfaction score for each question and category, providing attendee opinion data for the aspects of the event addressed in the free form response section of the survey. The AI language analysis may be based on natural language processing (NLP) or computational linguistics. The text of an open-ended attendee survey response may be analyzed using NLP to ascertain consumer-identified topics or issues that relate to a survey category, in order to properly categorize the attendee data to facilitate analysis and response to such open language data.

As described in step 307B, the AI language analysis module may also analyze the attendee sentiment relating to that survey category based on the language used by the attendee in their narrative response (e.g., analyzing the language in the response for emotive language, such as positive and negative adjectives, positive and negative slang or abbreviations, the nouns to which the positive and negative language elements refer [e.g., the food, staff service, etc.], and other aspects of the language used in the attendee's responses). For example, the AI analysis module may have analyzed the attendee response 114A on FIG. 5 and associated the sound system with a positive value and associated the volume level with a negative value. The AI analysis may also interpret the punctuation on attendee response in 114A as emotionally elevated, and further increase the magnitude of the value associated with the response. As another example, the AI analysis module may have analyzed the attendee response 114B, interpreted slang accordingly, and associated food with a neutral value while associating alcoholic beverages with a positive one.

The AI language analysis module may also conduct weighting analysis of responses in step 307B, assigning more weight to answers that include words that indicate high emotional level, a pre-determined volume of characters, indicating either a lack of engagement or importance (e.g., when answers are below a minimum character threshold), or a high level of engagement or importance (e.g., when answers are below a minimum character threshold).

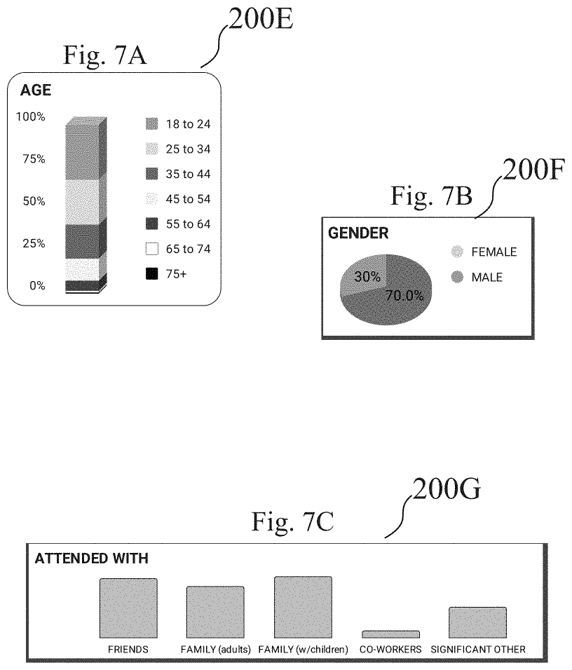

In step 307B, system modules may include a critical “at risk” issues module 200D that identifies specific types of critical issues that are addressable during the event, see FIG. 7. These critical issues may be determined by pre-existing categories and questions within the survey that are coded as critical (e.g., lavatory malfunction, PA malfunction, etc.) and thus certain survey responses may automatically raise “at risk” issue. For example, if there is an influx of surveys from attendees that have a bathroom rated lower than nominal, the system may automatically flag the bathroom near them as at risk. Also, the AI language analysis module may identify critical issues raised in narrative answers provided to open-ended questions in the survey by identifying terms associated with critical issues. For example, as shown on FIG. 7, the AI may analyze the narrative responses in the survey data for nouns such as bathroom, adjectives, such as flooded or broken, and other word forms associated with pre-determined critical issues and generate a report of a critical issue 119B for the critical issue module 200D of the system dashboard. The at risk issue 119 may be localized to the attendee location from which the survey responses were submitted and the data analysis system may correlate the metadata associated with the relevant survey responses (e.g., the location of the mobile computing device(s) reporting the issue on through the survey responses, the seat or location assignment for the attendee submitting the survey responses, the time of the submission of the relevant survey responses, etc.) with the at risk issue raised to determine the likely location of the at risk issue. The event/social experience producer 110 may then respond to such at risk issues 119 in real time by contacting staff to address the identified at risk issue. The event/social experience producer may also contact the attendee(s) who raised the issue through electronic communication (e.g., a text, push notification, or other electronic communication) to the mobile computing device(s)102 used to submit the survey responses. In some embodiments, the system may be operable to generate automated text, push notifications, or other electronic communications to staff to identify the at-risk issue and instruct the staff to investigate and address the critical issue. In some embodiments, the system may be operable to generate automated text, push notifications, or other electronic communications to attendee(s) who raised the relevant critical issue 119 to inform the attendee that the at risk issue is being addressed by event staff. The system may also track and record instances of at risk issues at an event and correlations between such at risk issues and attendee satisfaction scores overtime to determine which categories of at risk issues are more impactful on attendees' subjective satisfaction with an event and adjust the at risk categories and responses to such at risk issues accordingly.

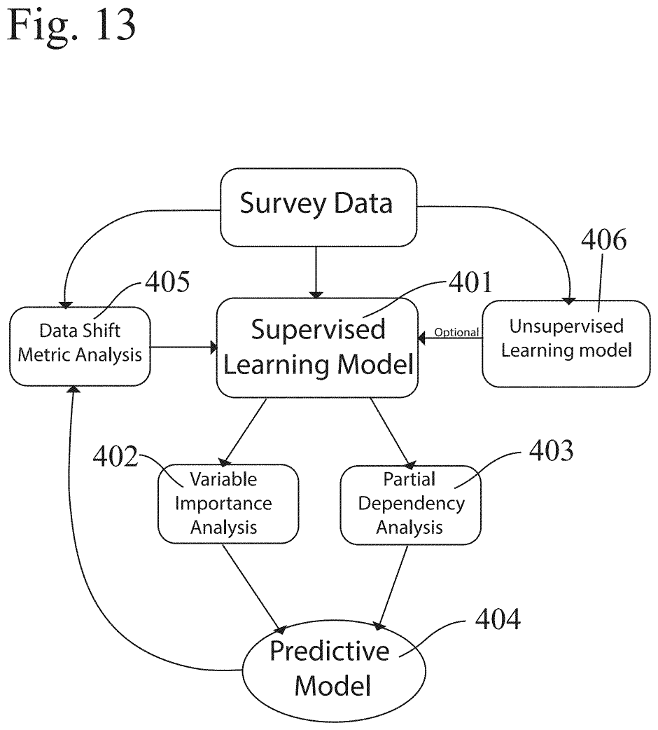

FIG. 13 shows a flow chart for operation of a data analysis system of the present invention. The data analysis system may comprise machine executable instructions that include novel predictive modeling techniques. Survey data collected by the data analysis system may be used for training by the supervised learning model 401 to generate a predictive model 404 that applies statistical analyses to data variables (e.g., survey questions and categories directed to aspects of an event or social experience) and related scores (e.g., past survey data for the survey questions and categories) to provide actionable information to the event/social experience producer about which aspects of the event or social experience to address or change to enhance guest/attendee satisfaction. The predictive model 404 may be updated over time based on analysis by the supervised learning model of a continuously expanding survey data set collected from multiple related events (e.g., multiple sports events held by a particular team) to determine which of the types of satisfaction data is associated with overall satisfaction with the event. Once the data analysis system is trained for the particular kind event, the variable importance analysis 402 is used in predictive modeling to determine which aspects of the new event or social experience will best enhance the guest/attendee satisfaction with the event or social experience. The supervised learning model 401 may be incorporated into the data analysis system as machine-executable instructions in a machine learning module. The machine learning module may update the predictive model 404 for a particular kind of event (e.g., basketball games of a particular professional team, amusement part general attendance experience, etc.) after each new data set is available, after a pre-determined amount of new data sets are available, after a specified period of time, or other selected criteria for updating the predictive model 404.

A partial dependency analysis 403 may be used to isolate each variable (e.g., bathroom cleanliness, bathroom facility, bathroom location/availability, staff friendliness, etc.) and determine its influence on overall satisfaction scores, and train the data analysis system to recognize such data variable relationships. Variable importance analysis 402 may show that bathroom cleanliness is highly influential on overall satisfaction scores, but it may be the case that its influence is a proxy for staff friendliness, thereby producing a variable importance analysis confounded by the subtle link between bathroom cleanliness and staff friendliness. Partial dependency analysis 403 isolates particular variables in the data based on their correlation (e.g., a correlation over about 0.7) in order to determine whether there is dependency between two or more variables. As an example, data from different types of events and social experiences for particular sets of correlated variables (e.g., bathroom cleanliness conditions in combination with constant staff friendliness scores) can be analyzed statistically by the data analysis system and used to update the predictive modeling 404 to include intervariable dependencies that are found in the data by the partial dependency analysis 403. The partial dependency analysis 403 may be performed by machine-executable instructions that are incorporated into the machine learning module.

In some embodiments, unsupervised machine learning 406 may be used to create contribute to the predictive models utilized by the data analysis system. Survey data collected by the data analysis system may be analyzed by an unsupervised machine learning model 406 such as a K-Means or Hierarchical Clustering model, Principle Components Analysis (PCA) model, Exploratory Factor Analysis (EFA) model, Confirmation Factor Analysis (CFA) model, or Random Forest model. In some embodiments, the unsupervised machine learning model 406 may be used as an alternative tool to the supervised learning model 401 for generating predictive models for use in the data analysis system. In other embodiments, the analysis provided by unsupervised learning model 406 may be used to train the supervised learning model 401 discussed above. In some embodiments, the unsupervised learning model 406 may be incorporated into the machine learning module.

The predictive model 404 incorporated into the data analysis system are updated overtime as new survey data is collected from guest/attendees by the data analysis system. The accuracy of the predictive model 404 can also be further adjusted by testing the predictive effectiveness of the predictive model 404 produced by the machine learning model 401 (including the variable importance, and, in some embodiments, the partial dependency analysis). The predictive model 404 may be tested for its predictive power against an actual data survey outcome that has not yet been incorporated into the supervised learning model 401. A data shift metric analysis 405 may be incorporated into the machine-executable instructions of the data analysis system and may be used to test the accuracy of the predictive model 404. The data shift metric analysis 405 may be used to test the accuracy of the predictive model 404 with each new related event (e.g., each successive basketball game), after a pre-determined amount of new data sets are available, after a specified period of time, or other selected criteria for applying the data shift metric model.

The data shift metric analysis 405 may determine that the new data is no longer has a sufficiently significant connection between predictive model 404 and target details. The predictive model 404 of the present invention are repeatedly updated over time to both increase the accuracy of the predictive model and to determine shifts in the guest/attendee preferences over time. Thus, the data analysis system of the present invention may be used by the event/social experience producer to stay informed and updated on overall fan satisfaction for the particular kind of event and the shifts in guest/attendee preferences.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A method collecting and analyzing data provided by attendees of a social event, comprising:
a. providing a medium for collecting data regarding said social event to said attendees;
b. collecting data provided by said attendees through said medium;
c. analyzing said data using a machine learning model to generate a data analysis report indicating a prioritized scoring of aspects of said social event based on said data; and
d. delivering said data analysis report to one or more persons managing said social event during said social event.

16. (canceled)

17. The method of claim 15, wherein said providing said medium for collecting data comprises providing a link to a webportal, mobile application, or computer application via electronic transmission to mobile computing devices or other computing devices of said attendees, and providing survey inquiries through said web portal, mobile application, or computer application.

18. The method of claim 15, wherein analyzing said data is performed as data are received from said attendees in real time and said data report is updated as new data provided by attendees through said medium is received.

19. The method of claim 17, wherein said survey inquiries include categories of questions addressed to different aspects of the social event.

20. The method of claim 19, wherein said different aspects of said social event include at least one of featured activities, concessions, facility quality, and social event personnel performance.

21. The method of claim 15, wherein generating said data analysis report further comprises generating a predictive model prioritizing said aspects of said social event and said predictive model is revised when new data is provided by said attendees.

22. The method of claim 21, wherein generating said predictive model includes partial dependency analysis, which includes comparing at least two correlated variables to determine whether survey data for one of said at least two correlated variables is dependent on data for a second of said at least two correlated variables.

23. (canceled)

24. A method collecting and analyzing data provided by attendees of an entertainment experience, comprising:
a. sending electronic notifications to said attendees to respond to an electronic survey form;
b. collecting responses to said survey form provided by said attendees;
c. analyzing said data using a data analysis system that includes a machine learning model that performs a variable importance analysis of at least one individual inquiries in said survey and categories of said individual inquiries to generate a data analysis report indicating a prioritized scoring of topics related to said entertainment experience; and
d. delivering said data analysis report to one or more persons managing said entertainment experience.

25. (canceled)

26. The method of claim 34, wherein said data report is delivered to said graphical user interface during said entertainment experience such that said one or more persons managing said entertainment experience can use said data report to take actions to address issues raised by said responses and alter aspects of said entertainment experience based on said responses.

27. (canceled)

28. The method of claim 34, wherein analyzing said data is performed as data are received from said attendees in real time and said data report is updated as new data provided by attendees through said medium is received.

29. The method of claim 24, wherein said survey inquiries include categories of questions addressed to different aspects of the entertainment experience.

30. (canceled)

31. The method of claim 15, wherein generating said data analysis report further comprises generating a predictive model prioritizing said aspects of said social event and said predictive model is revised when new data is provided by said attendees.

32. The method of claim 31, wherein generating said predictive model includes partial dependency analysis, which includes comparing at least two correlated variables to determine whether survey data for one of said at least two correlated variables is dependent on data for a second of said at least two correlated variables.

33. (canceled)

34. An electronic experience analytics system operable to
i. receive survey data from a plurality of devices,
ii. perform a set of machine executable instructions to analyze said data, and
iii. determine a significance score of survey questions and/or categories in real time from via said set of computer executable instruction;
wherein said set of computer executable instruction is based upon at least one of the following data: quantitative responses in survey data, amount of responses to said question and/or in said question category, and key words or phrases found in survey responses.

35. The system of claim 34, wherein said set of computer executable instruction incorporates time sensitive data, including one of the following:
a. the time at which question, category, and/or survey were completed; and
b. a contemporaneous activity at the time the survey was conducted

36. The system of claim 34, wherein said set of computer executable instruction incorporates the profile data of each user of a device from said plurality of devices, including one of the following:
a. age and gender of the user;
b. people who attended the event with the user;
c. location of said user within the event site; and
d. expenditures made by the user at said event.

37. The system of claim 34, wherein said set of computer executable instruction perform the following steps:
a. ranking the respective questions and categories of said quantitative responses,
b. alternatively, ranking quantitative response by an empirical percentile, or
c. ranking quantitative responses by a weighted combination of said z-score and said empirical percentile.

38. The system of claim 34, wherein said set of computer executable instruction further comprises an automated linguistic analysis operable to determine sentiment of survey responses based on word usage, grammar, and punctuation via a neural network based artificial intelligence.

39. The system of claim 34, wherein said electronic experience analytics system utilizes a machine-readable code to connect said plurality of devices to a survey.

40. (canceled)

41. The system of claim 34, wherein said electronic experience analytics system further comprises a dynamic dashboard with customizable modules that are adjusted automatically or manually in real time depending on event staff preference and/or survey responses.

42. (canceled)
